(19) United States
(12) Patent Application Publication
(10) Pub. No.: US 2006/0224957 A1
(43) Pub. Date: Oct. 5, 2006

(54) Chemically activated highlighting system and method

(76) Inventors: Ryan Jense, Seattle, WA (US); Devin Khoury, Missoula, MT (US); Dave Khoury, Albuquerque, NM (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/221,362

(22) Filed: Sep. 7, 2005

Related U.S. Application Data
(60) Provisional application No. 60/666,011, filed on Mar. 29, 2005.

(51) Int. Cl. G06F 17/00

(52) U.S. Cl. 715/530

(57) ABSTRACT

A system and method for highlighting indicia on a printed page that includes applying a compound to a printed page that is in a transparent clear state and providing an actuator that when applied to the compound causes the compound to change to a transparent color state for visually highlighting the indicia on which the compound is applied. An optional deactivator causes the compound to change from the transparent color state to the transparent clear state.

### BACKGROUND OF THE INVENTION

1. Field of the Invention

The present invention pertains to highlighting of text and other markings, and to a chemical reaction to develop a pre-existing latent image with a second developing agent, thereby revealing a colored image that can be employed in educational and other activities.

2. Description of the Related Art

Highlighting is the process by which a reader emphasizes printed material, such as portions of text. Currently, the reader has access to few highlighting techniques. Two examples involve either a marker-type tool that transfers color to the paper or the use of tape to cover previously printed text. Most marker-type highlighters accent text by use of a bright color that does not obscure the highlighted text. Often the highlighting is not aesthetically pleasing; it may not be straight, maybe uneven in quality or character, and may extend beyond areas of printed text. Highlighting tape has similar faults as marker-type highlighting and relies on the tape adhesiveness to maintain a highlighted portion of text. After a period of time, the tape can be dislodged or unintentionally removed. This results in the loss of highlighted text, time, and effort. Many people, displeased with uneven and unsightly highlighting, have settled with meticulously underlining portions of text with pen or pencil, with and without a ruler, as an alternative. Others simply forgo highlighting altogether.

Prior methods employ latent imaging for games, coloring, and other forms of entertainment. It has been proposed in prior U.S. Pat. No. 3,638,335 that quick, positive reinforcement improves learning and interest. When a student is able to highlight text easily with nearly perfect results, he or she is able to move forward without further distraction. It will be more pleasing to review the highlighted material, and there will be fewer distractions.

### BRIEF SUMMARY OF THE INVENTION

The disclosed embodiments of the invention are directed towards a system and method for highlighting indicia on a printed page that offers an innovative method of marking text in a clean, precise manner that will both facilitate learning and save time for students and professionals alike. By introducing this novel learning tool, the user will now be able to spend time efficiently reviewing the highlighted text. There will be no struggling to underline text meticulously with a ruler or the like.

This novel product has other applications as well. The same process can be used in textbooks to reveal latent text independently or in combination with latent highlighting. The text may be answers to questions, latent references, latent hints or clues, or other related text.

Thus, the embodiments of the invention are directed to a system and method of highlighting selected portions of printed text on a reading surface and of revealing by use of a special chemically activating highlighter what would otherwise remain undetected by the reader. Additionally, a method of returning the text to its original state is included by means of a second highlighting tool. This will return the disclosed text to its original latent state without disturbing the remaining text and enable repeated highlighting and removing highlighting with the method of the present invention.

In one embodiment a means of highlighting written text in a manner that elucidates important portions of the text with even, precise, and regular lines is provided. This method is more aesthetically pleasing than using traditional highlighters to accomplish the same task. Moreover, the invention can be used by an author or publisher to indicate portions of text, reveal margin notes, indicate answers to questions, or as a reference mechanism. This multi-step system begins by printing or treating the desired portions of the page containing text with a first compound called “Part A.” Part A, when applied to the page, is dry and invisible to the naked eye, and it does not in any way distract from or accent the portions of page or printed text. When Part A comes in contact with a second compound called “Part B,” a chemical reaction transforms the previously latent image into a predetermined color. Part B is contained in a hand-held applicator approximating the size of a pen or pencil or common highlighter in use. However, Part B when applied to text or the page does not change the color of, or contrast the text or page untreated by part A. The production of color intended to contrast the text and paper will only occur when Part B comes in contact with Part A, as each separately is not visible on the page. The final color of the latent image can be determined by Part A or by Part B, with many different colors available.

The latent image of Part A can be applied in a number of ways to accomplish the goal of highlighting important or relevant text. It can be applied in a fine, straight line under each line of text, as a fine line through the text, as bold lines in either of these locations, or in other manners apparent with an understanding of this invention. Alternatively, the text itself could be manufactured similar to Part A and change color when contacted by Part B. The latent image is invisible to the user until it is developed with the applicator. The applicator causes a chemical reaction that produces color that is restricted to the previously indicated latent image, thereby emphasizing that portion of text. No mark or color is made if the applicator is applied to the paper in an area without a preprinted latent image.

Other uses include revealing answers to questions and revealing references. In some instances, the author, editor, or publisher may wish to identify particular works or phrases that he or she deems important. For example, a learning device may have a number of sentences with instructions to find the verb, noun, adjective, etc. Each could be underlined with a latent image (possibly each in a different color), or a specific word such as “noun” could be printed as a latent image below the noun in the sentence. The user would then use the applicator of Part B to receive direct feedback. Furthermore, any word or term deemed important by the author could be referenced by placing the page number as a latent image beneath the desired word or term that directs the reader to the page with a definition or explanation. The reader would save time and effort by negating the need to refer to a traditional index proper to find the desired page.

In one embodiment, a system for highlighting is provided that includes a compound produced on a reading surface that is transparent; and an activator for application to the compound to activate the compound when applied thereto and to cause the compound to change from a transparent state to a nontransparent state in order to present visually distinct highlighting indicia underlying the compound.

In accordance with the above embodiment, the system for highlighting optionally further includes a deactivator for application to the compound that causes the compound to change from the nontransparent color state to the transparent clear state.

In another embodiment, a method of highlighting is provided that includes applying a compound to a reading surface as a latent image with fixed dimensions and color, the compound having a transparent clear state; and applying an activator to the compound to cause the compound to change from a transparent clear state to a transparent color state that contrasts with a color of the printed page and visually highlights indicia underlying the compound.

In accordance with the above embodiment, the method optionally further includes applying a deactivator to the compound to cause the compound to change from the nontransparent color state to the transparent clear state.

In still yet another embodiment, the illuminating system is provided that includes a transparent compound on a reading surface; and an activator for application to the transparent compound that interacts with the transparent compound and changes the appearance of the reading surface to present a visually-distinct color for highlighting indicia underlying the transparent compound.

In accordance with the above embodiment, the illuminating system optionally further includes a deactivator that causes the transparent compound on the reading surface to change from the nontransparent state to the transparent clear state.

### BRIEF DESCRIPTION OF THE DRAWING

FIG. 1 is an illustration of text and latent image on a printed page in accordance with the invention.

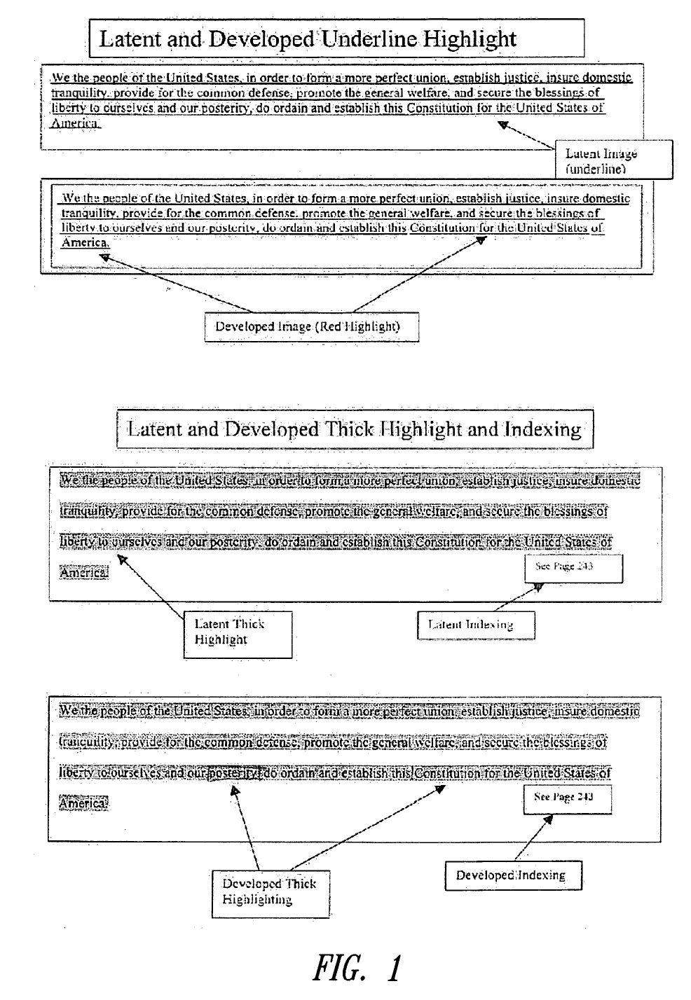

### DETAILED DESCRIPTION OF THE INVENTION

The scribing of invisible ink onto a writing surface and then revealing the hidden scripting with another otherwise invisible device has been well reported in the past. Inks and developers include compounds such as leuko dyes, pH indicators, and any other inorganic or organic materials that when mixed produce color, or any other reasonable enhancement, such as fluorescence. These colors should not obstruct the text or inhibit the reading experience in any way. Instead, they will highlight the desired textual portion in a neat and precise manner, thereby enhancing the reading and learning experience. The best compounds will produce colors that are durable, bright, and readily apparent. If desired, compounds can be used that allow reversal of the highlighting reaction to restore a latent image.

Many available compounds can be used to produce the novel application of latent imaging as described here. An example is an acidic solution of hydrazine salt and a stronger solution of that same salt with dimethylamino benzaldehyde. When this comes in contact with the stronger solution of the salt, a red/orange color is formed. Another example is the combination of ink containing a color coupler, such as benzoyl-leucomethylene blue, and a color-coupling additive such as 2-Hydroxybenzoic acid zinc salt. When the color-coupling additive is applied through the applicator, Part B, the reaction takes place and the section of desired text will be neatly chromatized. Any number of other chemical combinations can be employed to achieve the same effect, and are therefore applicable to this process. This patent describes a novel and advantageous manner of highlighting text, images, etc., and is independent of the specific chemicals utilized. The present invention improves existing highlighting in a manner analogous to the enhancement of existing games by Lenkoff in U.S. Pat. No. 3,826,499.

It is unnecessary herein to give details as to the composition of any of the invisible inks or methods of returning the text to its original form as this is discussed in detail in many texts, such as the following expired patents: U.S. Pat. No. 1,884,197 to H. J. Peterson et al.; U.S. Pat. No. 2,618,866 to C. S. Adams; U.S. Pat. No. 3,363,336 to B. F. Skinner; U.S. Pat. Nos. 3,979,550 and 4,525,214 to Panken; U.S. Pat. Nos. 4,111,462 and 4,205,865 to Lange et al.; U.S. Pat. No. 4,334,015 to Yarian; U.S. Pat. No. 4,322,466 to Tomlinson; and U.S. Pat. No. 4,263,047 to Miyamoto et al. Moreover, a leuko dye marking system that was described in U.S. Pat. No. 6,124,377 to Kaiser et al. could be used in the present invention or with the system described in U.S. Pat. No. 5,415,434 to Kawashima where it may be repeatedly chromatized/achromatized.

Any of the above mentioned compounds are printed onto the reading surface as a precise latent image. The author, editor, publisher, or any combination will determine which latent image options should be placed onto the printed surface. The latent images can be applied at any point in the publishing process by any means the publisher desires. The latent images (Part A) can be applied in a number of orientations, including: (1) a line of any width directly beneath the text; (2) a line of any width directly through the middle of the text; (3) hidden indexing under a desired word or term using any font; (4) hidden answers to questions within the text using any font; (5) underlying of specific words/terms such as nouns, verbs, adjectives, or any other notable word/term that the reader must identify as a learning tool; (6) printing text that is visible to the reader, but act as Part A, and change color when Part B is applied; and (7) any other obvious extension of this process including returning the highlighted text back to its original appearance or to its latent form.

The illuminating device will be in the form of a common highlighter presently in use or any other similar device that can transfer a compound (Part B) onto a reading surface. The illuminating device will contain a compound (Part B) that is completely transparent until it interacts with the invisible ink (Part A). That is, the illuminating compound will be clear and will not change the color or appearance of the reading surface or printed material thereon unless that portion of the surface has been treated with Part A. However, when the illuminating compound (Part B) comes into contact with any area of the reading surface that has been treated with Part A, a nearly instantaneous reaction takes place that causes the latent image to be revealed in the form of color. The illuminator compound (Part B) or the pre-applied compound (Part A) will determine this color. For example, if the reader desires a blue highlight, then the reader would use the blue illuminator and so forth for any color of the spectrum with a correlated Part A.

Or, the publisher could determine the color(s) with Part A (different colors denoting different objectives, for example) and then the same Part B would reveal different colors. Any combination of these two color-determining schemes could be used as well. Moreover, the color could be entirely translucent, completely opaque, or any variation of the spectrum between them.

Part A, Part B, or both could also determine the quality. For example, if the author or publisher desires to index a word with a reference beneath the text in an opaque color, this would be possible as well. On the other hand, if the author or publisher desired to highlight a line through the middle of the text, then a translucent combination of Part A and Part B would be more appropriate. After the illumination process has occurred, the revealed image will in effect become a portion of the text and will not fade, smear, or blur in an untimely manner. In addition to the aforementioned process, once the illumination has occurred, a similar but reverse process can be implemented to return the highlighted text back to its original state. This can be completed using another hand-held device, Part C, similar to Part B in design but with different compounds or liquids that will return the highlighted text back to its original, undetected state. Part C is not visible when applied to the page by itself and will not affect the text treated with Part A unless Part B has activated Part A. This optional eraser will be useful to the user if information is no longer needed or if a mistake has been made. It also benefits subsequent owners of the text, providing an option to edit the previous highlighting. Other developing highlighters could also be fashioned to change the color of the current highlight as a further editing option. An illustration can show highlighted text, already activated with Part B, coming in contact with Part C. The area Part C has activated will be latent while the rest of the text remains activated by Part B, and therefore highlighted.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and the equivalents thereof.

1. A system for highlighting, comprising:
a compound produced on a reading surface that is transparent; and
an activator for application to the compound to activate the compound when applied thereto and to cause the compound to change from a transparent state to a nontransparent state to present a visually-distinct highlighting indicia underlying the compound.

2. The system of claim 1 wherein the compound produced on the reading surface comprises an acidic solution of hydrazine salt and a solution of hydrazine salt with dimethylamino benzaldehyde.

3. The system of claim 1 wherein the activator for application to the compound comprises a stronger solution of hydrazine salt than the compound produced on the reading surface.

4. The system of claim 1 wherein the compound produced on the reading surface comprises a color coupler.

5. The system of claim 1 wherein the activator for application to the compound comprises a color-coupling additive.

6. The system of claim 1 wherein the compound produced on the reading surface comprises a latent image having fixed dimensions and color.

7. The system of claim 1 wherein the compound on the reading surface comprises a line of any width directly beneath the text.

8. The system of claim 1 wherein the compound on the reading surface comprises a line of any width directly through the middle of the text.

9. The system of claim 1 wherein the compound on the reading surface comprises invisible indicia under a desired text.

10. The system of claim 1 wherein the compound on the reading surface comprises visible text.

11. The system of claim 1 wherein the activator for application to the compound changes the color of the compound on the reading surface, the compound having the form of visible text.

12. The system of claim 1, further comprising a deactivator for application to the compound that causes the compound to change from the nontransparent color state to the transparent clear state.

13. A method of highlighting, comprising:
applying a compound to a reading surface as a latent image with fixed dimensions and color, the compound having a transparent clear state; and
applying an activator to the compound to cause the compound to change from a transparent clear state to a transparent color state that contrasts with a color of the printed page and visually highlights indicia underlying the compound.

14. The method of claim 13 further comprising applying a deactivator to the compound to cause the compound to change from the nontransparent color state to the transparent clear state.

15. The method of claim 13 wherein applying the compound to a reading surface as a latent image includes applying the compound to form a line having any width directly beneath the text.

16. The method of claim 13 wherein applying the compound to a reading surface as a latent image includes applying the compound to form a line having any width directly through the middle of the text.

17. The method of claim 13 wherein applying the compound to a reading surface as a latent image includes applying the compound to form visible text.

18. The method of claim 13, further comprising producing the compound applied to the reading surface from an acid solution of hydrazine salt and a solution of hydrazine salt with dimethylamino benzaldehyde.

19. The method of claim 13, further comprising producing the compound applied to the reading surface from a combination of ink containing a color coupler.

20. The method of claim 13, further comprising producing the activator applied to the compound on the reading surface from a color-coupling additive.

21. An indicia illuminating system, comprising:
a transparent compound on a reading surface; and
an activator for application to the transparent compound that interacts with the transparent compound and changes the appearance of the reading surface to present a visually-distinct color for highlighting indicia underlying the transparent compound.

22. The system of claim 21 wherein the transparent compound on the reading surface comprises invisible ink.

23. The system of claim 21 wherein the transparent compound on the reading surface comprises a predetermined ink that establishes the color of the highlighting indicia underlying the transparent compound when it comes into contact with the activator for application to the transparent compound.

24. The system of claim 21 wherein the activator for application to the transparent compound on the reading surface comprises a predetermined ink that determines the color of the highlighting indicia underlying the transparent compound.

25. The system of claim 21 further comprising of a deactivator that causes the transparent compound on the reading surface to change from the nontransparent state to the transparent clear state.
